(19) United States
(12) Patent Application Publication
(10) Pub. No.: US 2003/0050791 A1
(43) Pub. Date: Mar. 13, 2003

(54) Transaction mediation system and its methods

(76) Inventor: Ikuko Kato, Tokyo (JP)

Correspondence Address: LUCE, FORWARD, HAMILTON & SCRIPPS LLP, 11988 E1 Camino Real, San Diego, CA, 92130, US

(21) Appl. No.: 10/210,689

(22) Filed: Jul. 31, 2002

(30) Foreign Application Priority Data
Jul. 31, 2001 (JP) 2001-231396
Jul. 31, 2001 (JP) 2001-231397

(51) Int. Cl. G06F 17/60

(52) U.S. Cl. 705/1; 705/80; 705/26

(57) ABSTRACT

Buyers register their conditions of business objects they wish, in a database of the server in advance. If sellers have business objects to sell, they input the information of the business objects in the seller terminal, and then send it to the server. The server compares this business object information with conditions registered in the database, and selects the buyers whose condition corresponds to the business objects, and informs them about the business objects. The buyers who received the notice send the transaction reservation from their buyer terminals. The server informs the seller terminal about a state of the transaction reservations, which are sent from each of the buyer terminals. According to the state of the transaction reservation, the sellers select the way of transaction from selections that are prepared in advance, and then send it to the server. The server carries out processes that are necessary to accomplish the transaction in the way the sellers selected.

### BACKGROUND OF THE INVENTION

1. Field of the Invention

The present invention relates to a transaction mediation system and its methods. The system mediates the transaction of business objects (including intangible assets), and it is especially suitable to mediate business using communications networks.

2. Description of the Related Art

Network transactions that transact businesses on Web sites through the Internet are becoming active recently. The network transactions are carried out in some business ways, such as auction and bidding. Generally anyone can participate in these network transactions.

With regard to these open transactions, however, it is often the case that sellers and buyers who accomplished business do not know each other. Consequently, there happen troubles such as failing to deliver or settle for business objects. In order to avoid these kinds of trouble, some Web sites limit the participants of their network transaction to registered members. However, even his exclusive network transaction is not an adequate way to avoid troubles because some people get membership using false names. On the other hand, if identification procedures are made stricter, the complicated procedures may make it difficult for people to become members. In this way, conventional network-transaction sites have not achieved the goal of making sites safe enough or many people to use.

In the case of Internet auctions, buyers cannot know what kinds of thing are offered as business objects unless they watch them. If they do not watch business objects more frequently than the period of bidding, they cannot participate in transactions even if things they wish to buy are offered as business objects. Besides, even if buyers find things of their wish are offered as business objects, they might bid prices that are much higher than proper values, resulting in a loss

On the other hand, it is difficult for sellers to predict the extent of demand for things they are selling as business objects. In case of a network transaction in which sellers suggest prices (the prices for transaction itself, or the lowest prices to sell), there might be no buyers regardless of demand for the business objects, if the prices suggested by sellers were unacceptably high.

### SUMMARY OF THE INVENTION

The present invention relates to a transaction mediation system that enables business objects to be transacted in proper periods and prices. It also relates to a bidding system that enables business objects to be transacted in proper prices,

In order to achieve the above object, according to the first aspect of the present invention, there is provided a system for transaction mediation, connected to seller's and buyer's computers, and comprising: means for receiving business object information proposed by a seller; means for releasing the business object information to multiple buyers; means for receiving reservations for transaction made by buyers for the business objects; means for providing reservation state information for the seller; means for receiving transaction method selected by the seller from multiple transaction ways prepared in advance; and means for processing transaction for accomplishing the business object transaction between the seller and the buyer.

In the transaction mediation system, by obtaining reservation state information, sellers can predict demand for business objects before transaction is conducted. Therefore, sellers can select a way of transaction that they think proper for the business object, and make the transaction conducted with proper period and price.

The transaction mediation system may include means for registering information about multiple buyers who can participate in the transaction of the business object. In this cases the means for releasing may send the business object information to the registered buyers. Consequently, troubles such as failure to settle payment can be avoided, because buyers who can buy the business object is limited to those who registered in advance. Besides, sellers may be also limited to those who registered in advance, making it possible to avoid troubles such as failure to transfer business objects to buyers.

The means for registering information about multiple buyers may further register their conditions of business objects. In this case, the system may include means for selecting buyers, which compares a business object proposed by a seller with the registered buyers' conditions, and then selects buyers whose conditions are fulfilled with the business object. The means for releasing may send the business object information to the selected buyers. In this case, buyers are not bothered by getting unwanted information, and they can surely get necessary information about the business object of their wish, without watching the transaction.

The transaction mediation system may be connected to multiple terminals of buyers via network In this case, the means for releasing send information such as about the business object, to the buyer terminals.

In order to achieve the above object, according to the second aspect of the present invention, there is provided a system for transaction mediation, 26 connected to seller's and buyer's computers, and equipped with communication device, control unit, and storage. The storage stores information about buyers' condition of business object. The control unit carries out the following processes: 1) receiving business object information proposed by a seller with the communication device; 2) sending the received business object information to multiple buyers; 3) receiving reservations made by the buyers for the business object; 4) informing the selected seller via the communication device about a state of the reservations; 5) receiving a way of transaction chosen by the seller; 6) conducting processes necessary for accomplishing the transaction between the seller and the buyer.

In order to achieve the above object, according to the third aspect of the present invention, there is provided a system for transaction mediation, having: means for receiving business object information proposed by a seller; means for registering buyers' conditions of business objects in advance; means for comparing received business object information and registered conditions; means for receiving a way of transaction chosen by the seller according to results of the comparison, from selections of ways of transactions prepared in advance; and means for conducting processes necessary for accomplishing the transaction between the seller and the buyer in the received way of transaction.

In the transaction mediation system according to the third aspect of the present invention, sellers can obtain information about the results of the comparison such that how many buyers wish to buy the business object. Thus the sellers can predict the demand of the business objects before conducting the transaction. In this way, sellers can select a way of transaction that they think proper for the business object, and can make the transaction conducted in proper period and price.

In order to achieve the above object, according to the fourth aspect of the present invention, there is provided a system for transaction mediation, equipped with communication device, control unit, and storage. The system is connected via network to computers operated by sellers and buyers. The storage stores information about buyers' condition of business objects. The control unit carries out the following processes; receiving business object information proposed by a seller with the communication device; comparing received business object information with condition information registered in the storage; selecting a seller according to results of comparison; informing selected seller via the communication device; receiving a way of transaction chosen by the seller according to the result of the comparison, from selections of ways of transactions prepared in advance; conducting processes necessary for accomplishing the transaction between the seller and the buyer.

In order to achieve the above object, according to the fifth aspect of the present invention, there is provided a system for transaction mediation, comprising: a step of receiving business object information proposed by a seller; a step of releasing the received business object information to multiple buyers; a step of receiving reservations made by buyers for the transaction of the released business objects; a step of providing reservation state information for the seller; a step of receiving a way of transaction chosen by the seller according to a state of reservation, from selections of ways of transactions prepared in advance; and a step of conducting processes necessary for accomplishing the transaction between the seller and the buyer.

In order to achieve the above object, according to the sixth aspect of the present invention, there is provided a system for transaction mediation, having: a step of receiving business object information proposed by a seller; a step of comparing received business object information with condition information registered in advance; a step of receiving a way of transaction chosen by the seller according to results of the comparison, from selections of ways of transactions prepared in advance; and a step of conducting processes necessary for accomplishing the transaction between the seller and the buyer.

In order to achieve the above object, according to the seventh aspect of the present invention, there is provided programs for operating computers, having: means for receiving business object information proposed by a seller; means for releasing the received business object information to multiple buyers; means for receiving reservations made by buyers for a transaction of the released business object; means for providing reservation state information for the seller; means for receiving a way of transaction chosen by the seller according to the state of reservation, from selections of ways of transactions prepared in advance; and means for conducting processes necessary for accomplishing the transaction between the seller and the buyer.

In order to achieve the above object, according to the eighth aspect of the present invention, there is provided a program for operating computers, having: means for receiving business object information proposed by a seller; means for registering buyers' conditions of business objects in advance; means for comparing received business object information and registered conditions; means for receiving a way of transaction chosen by the seller according to results of the comparison, from selections of ways of transactions prepared in advance; and means for conducting processes necessary for accomplishing the transaction between the seller and the buyer.

In order to achieve the above object, according to the ninth aspect of the present invention, there is provided a bidding system having: the system is connected via network to computers operated by sellers and buyers; and having; means for receiving business object information proposed by the first participant of the transaction; means for releasing received business object information, in order to get second participant of transaction to bid for the business object; means for receiving bid price, for a certain period, bid by second participant of transaction according to the released information; means for selecting a bid price with limit value from those received in the means for receiving bid price; means for releasing the selected bid price with limit value, in order to get second participant of transaction to further bid for the business object; means for receiving bid price, for a certain period, bid by one or more buyers for the business object according to the released bid price with limit value; and means for determining the bidding of the business object, according to the bid prices received by the means for receiving bid price.

In the bidding system according to the ninth aspect of the present invention, bidding for the business object is carried out twice. The system releases the received result of the first bidding (the bid price with limit value) before carrying out the second bidding. Since the second participant of transaction can decide their final bid price according to the result of the first bidding, it enables the contract price to have proper value. Besides, by carrying out the second bidding, the first participant of transaction can also expect the transaction to have proper value for them.

In the bidding system according to the ninth aspect of the present invention, if any one of the received prices for the second bidding is more than the limit price of the first bidding, the means for determining bidding may determine a successful bidder as one of the second participants of transaction who bid the limit price of the second bidding.

In the bidding system according to the ninth aspect of the present invention, if received prices of the second bidding, except that of the successful bidder, are also more than the limit price of the first bidding, the means for determining bidding may determine a contract price according to a price being next to the limit price of the second bidding. Therefore, in the determination of the contract price, even if one of the second participants of transaction bid fairly high price (or low price), proper contract price can be determined because it is based on the price next to the bid price with limit value. On the other hand, the first participant of transaction can expect the bidding to be fairly high (or low) because of the determination mechanism.

In the bidding system according to the ninth aspect of the present invention, if bid prices with limit values received by the first and the means for receiving bid price differ to more than a certain extent, the means for bidding determination may release the bid price with limit value received by the means for receiving bid price, in order to get the second participant of transaction to further bid for the business object. The great difference between the bid prices received by the first and the means for receiving bid price implies that the bid price still has not become proper value. In this situation, it is possible to make bid price proper by releasing the bid price of the second bidding and calling for the third bidding.

The bidding system according to the ninth aspect of the present invention may include means for transaction-participants registration that is registered with second participants of transaction who can bid for the business object in advance. In this case, the means for releasing may send the business object information to the registered second participants of transaction.

In the bidding system according to the ninth aspect of the present invention, the means for releasing may send the bid price with limit value selected by the means for selecting bid price to the second participants of transaction, from whom the means for receiving bid price received a bid price. In this case, since the number of competitors who can participate in the second bidding is limited, the period necessary for second bidding can be shortened. Therefore, the time necessary to determine the successful bidder can be also shortened.

The bidding system according to the ninth aspect of the present invention may include; means for receiving stoppage information of transaction sent from the first participants of transaction according to the bid price of the first bidding released by the means for releasing; and means for stopping to terminate processes of the means for receiving bid price and the means for bidding determination, with the transaction stoppage information received by the previous process. In this case, the first participant of transaction can prevent the transaction from being conducted in improper prices for them.

In the bidding system according to the ninth aspect of the present invention, the first participant of transaction may correspond to a seller of the business object, and the second participant of transaction may correspond to buyer of the business object. In this case, the bid price with limit value corresponds to the highest bid price.

In the bidding system according to the ninth aspect of the present invention, the first participant of transaction may correspond to a buyer of the business object, and the second participant of transaction may correspond to seller of the business object. In this case, the bid price with limit value corresponds to the lowest bid price.

In order to achieve the above object, according to the tenth aspect of the present invention, there is provided a bidding methodology having: a step of receiving business object information proposed by a seller; a step of releasing business object information to the second participant of transaction in order to get them to bid for the business object; a step of receiving, within first period, prices bid from the second participant of transaction according to the released business object information; a step of selecting a bid price with limit value from the received bid prices; a step of releasing the selected bid price with limit value to the second participant of transaction, in order to get them to bid furthermore for the business object; a step of receiving, within second period, prices bid from multiple buyers for the business object according to the released bid price with limit value; and a step of determining the bidding of the business object according to the prices bid within the first and second periods.

In order to achieve the above object, according to the eleventh aspect of the present invention, there is provided programs for operating computers, having: means for receiving business object information proposed by a seller; means for releasing the received business object information, in order to get second participant of transaction to bid for the business object; means for receiving bid price for a certain period, bid by second participant of transaction according to the released information; means for selecting bid price with a limit value from prices received by the means for receiving bid price; means for releasing a bid price with the selected limit value, in order to get second participant of transaction to further bid for the business object; means for receiving bid price bid by one or more buyers for the business object according to the released bid price with limit value, for a certain period; and means for determining bidding of the business object, according to the bid prices received by the means for receiving bid price.

### BRIEF DESCRIPTION OF THE DRAWINGS

FIG. 1 is a block diagram showing the general structure of the network transaction system for a preferred embodiment of the present invention.

FIG. 2 is a block diagram showing the structure of the server in FIG. 1.

FIG. 3 is a block diagram showing the structure of the seller terminal in FIG. 1.

FIG. 4 is a block diagram showing the structure of the buyer terminal in FIG. 1.

FIG. 5 is a flow chart illustrating the member registration process.

FIGS. 6A and 6B are flow charts illustrating the transaction registration process

FIGS. 7A and 7B are flow charts illustrating the twice bidding process.

FIG. 8 is a flow chart illustrating details of the bidding determination process in FIG. 7B.

### DETAILED DESCRIPTION OF THE PREFERRED EMBODIMENT

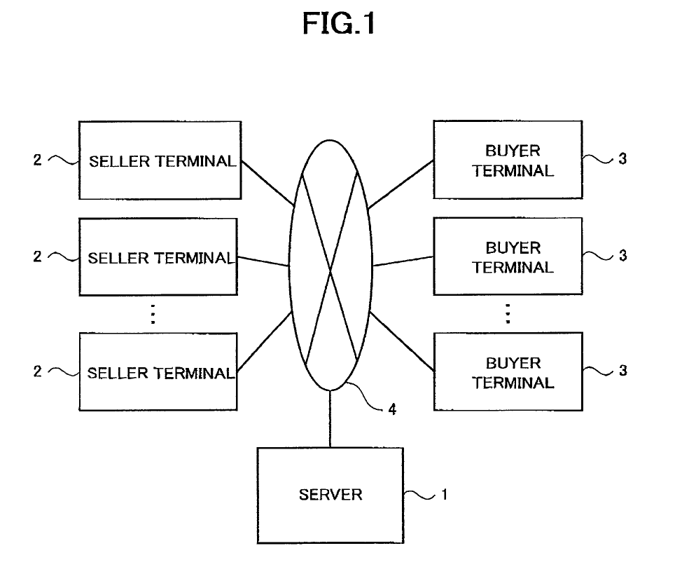

Details of an embodiment of the present invention will be described below using attached figures. FIG. 1 is a block diagram showing the general structure of the network transaction system for the embodiment of the present invention. The network transaction system mediates transaction of business objects between sellers and buyers. The system consists of a server 1, seller terminals 2, and buyer terminals 3. The seller terminals 2 and the buyer terminals 3 are connected to the server 1 with communications network such as the Internet 4.

The server 1 carries out processes necessary to accomplish the transaction of business objects between sellers and buyers, using information sent from the seller terminals 2 and the buyer terminals 3. The seller terminals 2 are used by sellers registered as members in advance, and carry out processes necessary to register business objects and the way of transaction. The buyer terminals 3 are used by buyers registered as members in advance, and carry out processes necessary to apply the transaction of business objects.

In the description of the embodiment of the present invention, the terms “seller” or “buyer” correspond to ones (persons or organizations) who are registered in the server 1 as users of this system, regardless if they actually transact business objects or not. Also, the terms “transaction” or “business” correspond to activities and processes that are necessary to determine sellers and buyers of business objects and the prices of transaction, not relating to transference of the business objects from sellers to buyers.

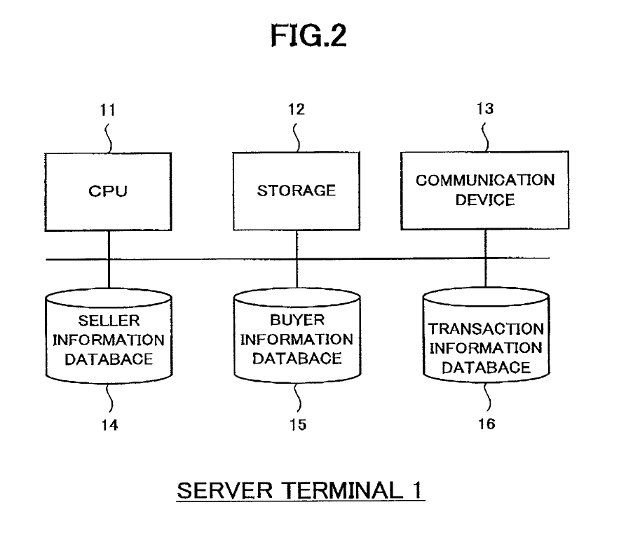

FIG. 2 is a block diagram showing the structure of the server in FIG. 1. As shown in FIG. 2, the server 1 is equipped with a CPU (Central Processing Unit) 11, a storage 12, a communication device 13, a seller information database 14, a buyer information database 15, and a transaction information database 16.

The CPU 11 constitutes the control unit of the computer, and runs programs stored in the storage 12 to carry out processes for accomplishing business object transaction. The storage 12 includes auxiliary storage, and stores the processing programs of the CPU 11, which are later shown in flow charts. The storage 12 is also used as a working storage for the CPU 11 at the time of running he programs. The communication device 13 is connected to the Internet, and sends and receives information with the seller terminal 2 or the buyer terminal 3.

The seller information database 14 is a database to store information about sellers of business objects, that is, the users of the seller terminal 2. The information to be stored in the seller information database 14 includes attributes such as names, addresses, telephone numbers, and e-mail addresses, and also includes sellers' identification (ID) and passwords (PW), which are issued at the time of member registration. Note that the passwords can be changed after registration.

The buyer information database 15 is a database to store information about buyers of business objects, that is, the users of the buyer terminal 3. The information to be stored in the buyer information database 15 includes attributes such as names, addresses, telephone numbers, and e-mail addresses, and also includes buyers' identification (ID) and passwords (the passwords can be changed later), which are issued at the time of member registration. Furthermore, he information to be stored in database 15 includes buyers' conditions of business objects, and the way of settlement (credit card numbers, bank accounts, etc).

The transaction information database 16 is a database to store information about each business object. The information to be stored in the transaction information database 16 includes: information about business objects themselves (in addition to functions, etc, it may includes images); information about buyers selected with a matching process, which is explained later; information about buyers who reserved transaction; information about the way of transaction sellers selected; and information about application from buyers such as bid prices for business objects, which is also described later.

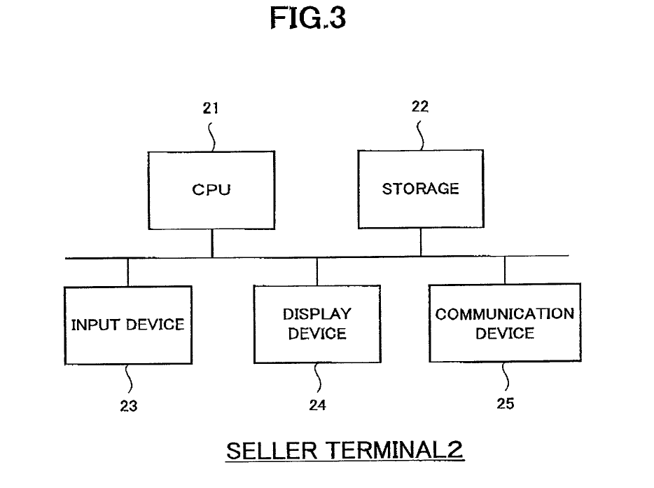

FIG. 3 is a block diagram showing the structure of the seller terminal 2 in FIG. 1. The seller terminal 2 consists of devices such as personal computers, and equipped with a CPU 21, a storage 22, an input device 23, a display device 24, and a communication device 25.

The CPU 21 runs programs stored in the storage 22, and carries out processes necessary to register business objects and ways of transaction. The storage 22 stores a processing program for the CPU 21, which is described later in flow charts. The storage 22 is also used as a working storage for the CPU 21 at he time of running the program. Now, the storage 22 stores at least a mailer program as application software, which sends and receives e-mails. The processes of the flow charts described later include those carried out by running his mailer program.

The input device 23 consists of devices such as a keyboard and a mouse, and it is used to input various information and instructions to the CPU 21. The display device 24 consists of devices such as a CRT and a liquid crystal display, and shows such information that sent from the server 1. The communication device 25 connects to the Internet 4, and exchanges information with the server 1.

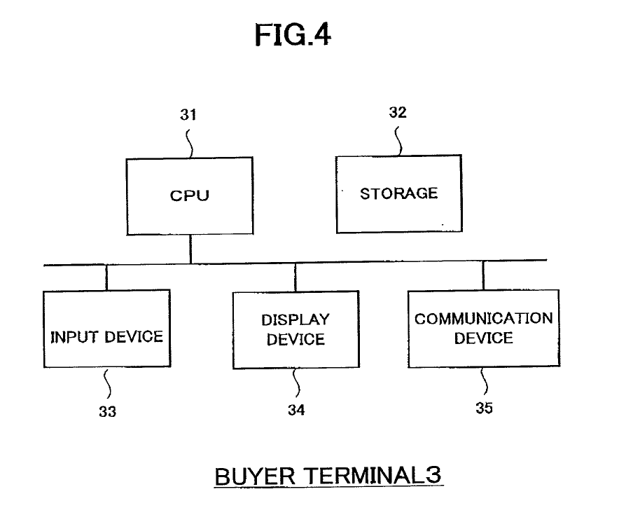

FIG. 4 is a block diagram showing the structure of the buyer terminal 3 in FIG. 1. The buyer terminal 3 consists of devices such as personal computers, and equipped with a CPU 31, a storage 32, an input device 33, a display device 34, and a communication device 35, as shown in FIG. 4. The functions of each devices of the buyer terminal 3 are the same as the counterparts of the seller terminal 2. The buyer terminal 3 also has sending/receiving functions of e-mail as the seller terminal 2.

The processes for the embodiment of the network transaction system are described below. Those who transact with this network transaction system (that is, sellers and buyers) have to be registered as members in advance.

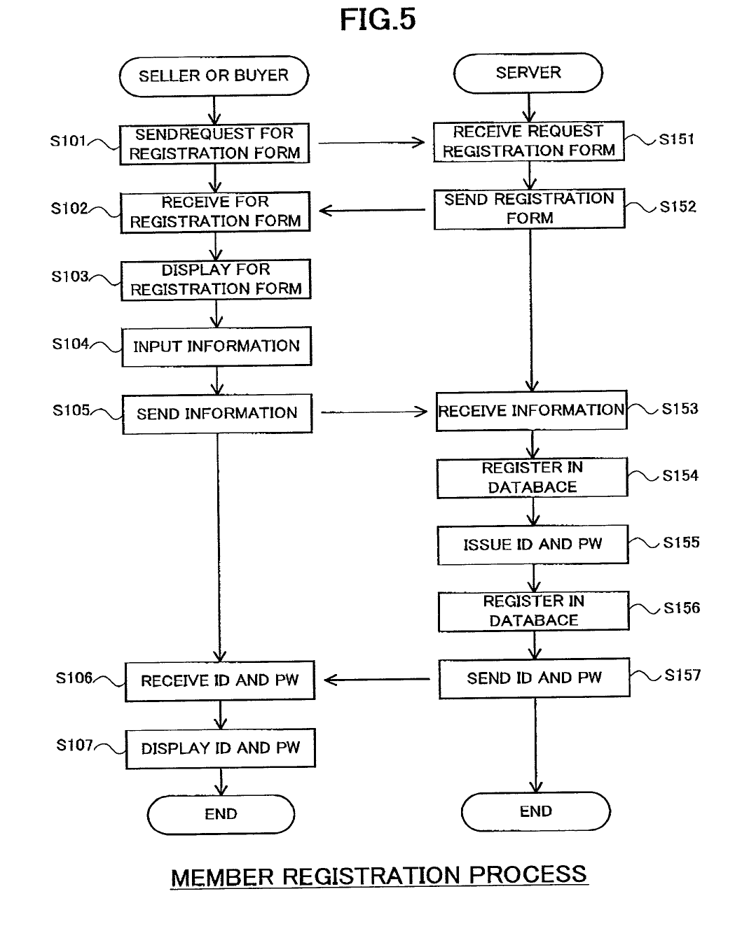

FIG. 5 is a flow chart illustrating the member registration process. Those who are going to be a seller or a buyer access the server 1 from their own terminals (the seller terminal 2 or the buyer terminal 3) via the Internet 4, and send requests for member registration forms, which are prepared separately for sellers and buyers (step S101).

When the CPU 11 in the server 1 receives requests from the seller terminal 2 or the buyer terminal 3 (step S151), it sends previously prepared member-registration forms for sellers or buyers to the seller terminal 2 or the buyer terminal 3 via the Internet 4 (step S152). When the communication devices 25 or 35 in the seller terminal 2 or the buyer terminal 3 receive member registration forms (step S102), the terminals show these registration forms on the display devices 24 or 34 (step S103). Next, those who are going to be a seller or a buyer input necessary information by operating the input devices 23 or 33, and then enter commands to send the information (step S104). Now, the necessary information inputted by the one to be a buyer includes conditions of business objects. Note that the term “conditions” corresponds to any properties of goods such as classification, type, price, functions, size, weight, maker's name, etc.

Then, the inputted information is sent from the communication devices 25 or 35 to the server 1 via the Internet 4 (step S105). When the communication device 13 of the server 1 receives information from the seller terminal 2 or the buyer terminal 3 (step S153), the server stores the received information to the seller information database 14 or the buyer information database 15 (step S154). Furthermore, the CPU 11 issues unique identification (ID) and password (PW) (step S155), and relates them to the received information, and then stores them in the seller information database 14 or the buyer information database 15 (step S156). The CPU 11 also sends the issued ID and PW to the seller terminal 2 or the buyer terminal 3 from which the information was sent to the server (step S157). Note that, by accessing the server 1 from the seller terminal 2 or the buyer terminal 3, the issued PW can be changed.

When the communication devices 25 or 35 of the seller terminal 2 or the buyer terminal 3 receive ID and PW (step S106), those terminals show them on the display devices 24 or 34 (step S107). By acquiring these ID and PW, the users can use the system as a seller or a buyer. The seller or the buyer commit the displayed ID and PW to, for example, writing, and use it later when logging in the server 1 to carry out the processes necessary to transact business objects, which are described later.

In the way described above, the registered sellers and buyers can transact business objects with this system. At first, in order to transact business objects, they have to register business objects and the way of transaction (transaction registration). To do this registration, they have to log in the server 1 from the seller terminal 2 or the buyer terminal 3, using the ID and the PW described above. However, the login process will be omitted in the following explanation.

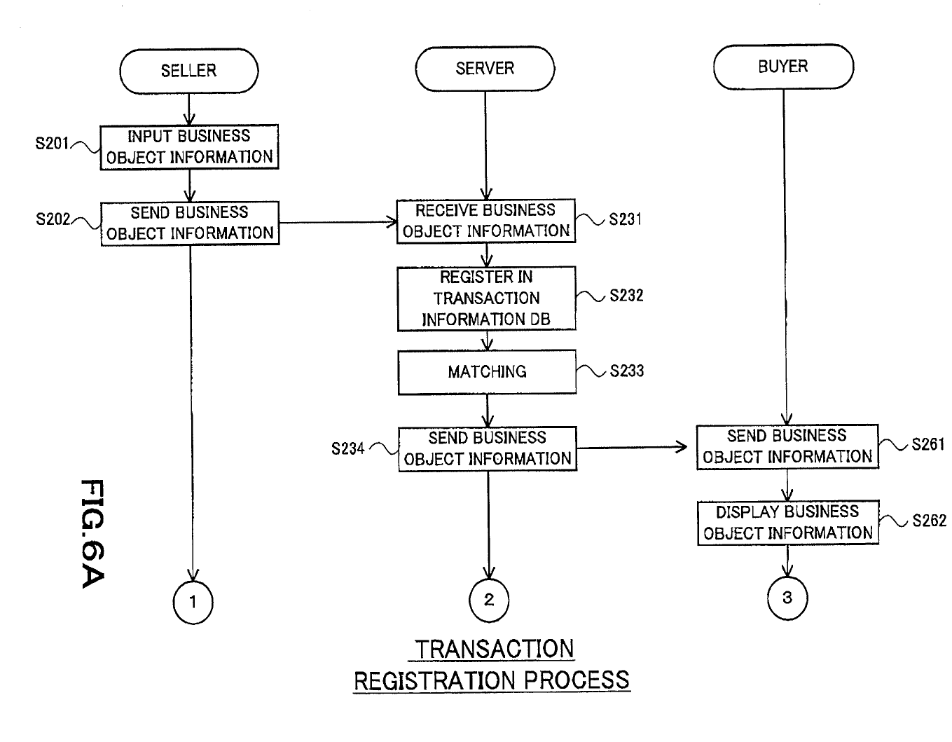

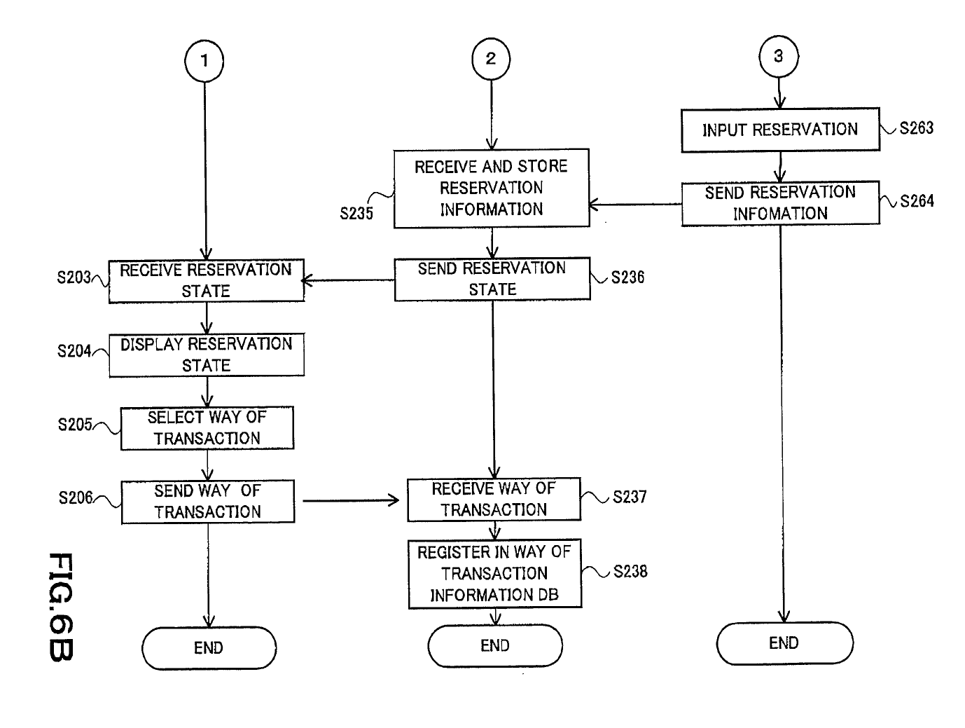

FIGS. 6A and 6B are flow charts showing the transaction registration process. If a seller has a business object to sell, at first he/she inputs the business object information with the input device 23 (step S201). Then, by inputting commands to send using the input device 23, the seller makes the terminal to send the information to the server 1 with the communication device 25 (step S202).

The communication device 13 of the server 1 receives the business object information sent from the seller terminal 2 (step S231), and then the server 1 registers the information in the transaction information database 16 as new business object information. The server 1 fixes the expiration date of the transaction reservation as the day after a certain period from the day of registration. Then, after relating the expiration date to the business object, the server 1 stores it in the transaction information database 16 (step S232).

Next, the CPU 11 compares the transaction object information with conditions stored in the buyer information database 15, and then selects buyers whose condition correspond to the business object (step S233, the matching process). Then the communication device 13 sends the object information to the e-mail addresses of the selected buyers (step S234).

The buyer terminal 3 receives the e-mail about the business object information with communication device 35 (step S261), and then it shows the information on the display device 34 (step S262). The buyer decides whether to reserve the transaction of the business object according to the business object information shown in the display device 34. The buyer who decided to reserve the transaction inputs a reservation with the input device 33 (step S263), and makes the communication device send the reservation information to the server 1 by inputting a certain command (step S264).

Until the expiration date of the transaction reservation registered in step S232, the communication device 13 of the server 1 receives the transaction reservations from the buyer terminals 3. Then, the server relates each reservation to the information about the buyer terminals 3 from which the reservation sent, and stores it in transaction information database 16 (step S235). When the transaction reservation expires, the server 1 gathers all the transaction reservations stored in the transaction information database 16 as reservation state information, and sends it as e-mails to the seller terminal 2 with the communication device 13 through the Internet 4 (step S236).

When the communication device 25 of the seller terminal 2 receives the e-mail of the reservation state (step S203), the terminal shows it on the display device 24 (step S204). According to the reservation state of the business objects shown on the display device 24, the seller chooses the way of transaction for the business objects. The seller inputs the chosen way of transaction by operating the input device 23 (step S205). Then, by inputting a certain command, the seller sends the information about the way of transaction to the server 1 with the communication device 25 through the Internet 4 (step S206).

The ways of transaction that sellers can choose from include the way in which sellers set the price and calls for buyers on first-in-first-served basis, auction, and bidding. The bidding includes the one completes with twice bidding, which is described later, as well as that completes with single bidding. In this case, sellers can predict the demand of business objects according to the reservation state information sent from the server 1, and can choose the best way of transaction that they think best.

When the communication device 13 of the server 1 receives the information about the way of transaction sent from the seller terminal 2 (step S237), the server relates it to the business object and registers it in the transaction information database 16 (step S238). This ends the transaction registration process.

After completing the registration process of the transaction in the way described above, questioning and answering (Q & A) about the business object are done between the seller and the buyers for a certain period. The server 1 mediates this Q & A, and uploads all the questions sent from buyers and the seller's answer for each of the questions on a bulletin board on the network. After the period of Q & A, the transaction is carried out in the way the seller selected in the transaction registration process described above and stored in the transaction information database 16. Now, since the ways of transaction except the twice bidding are the same as the conventional ways that are carried out in the Internet 4, we will describe below the process of transaction with twice bidding (twice bidding process).

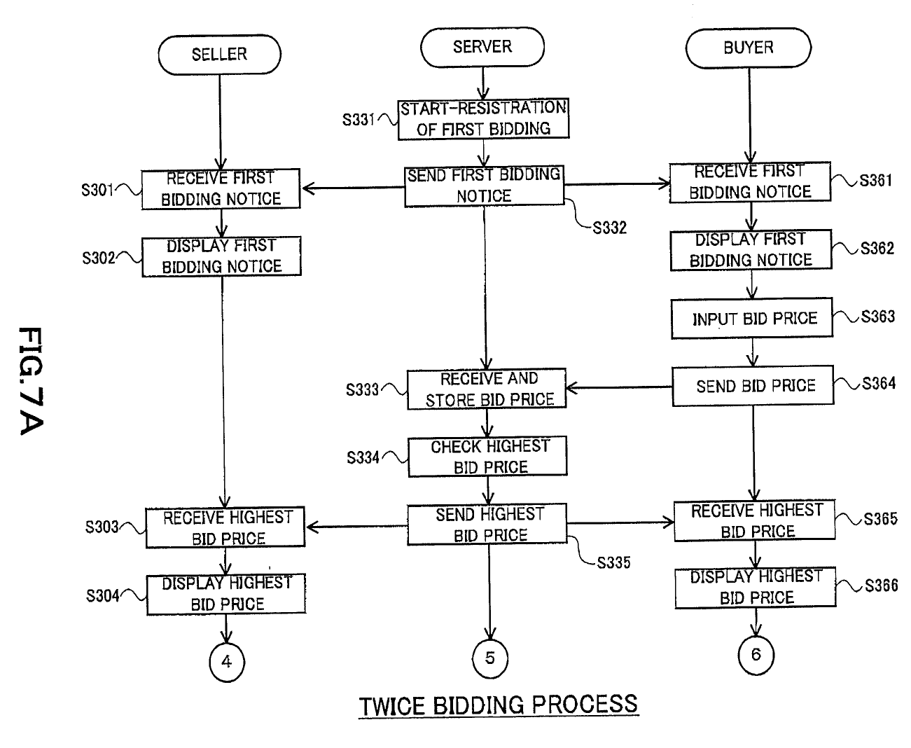

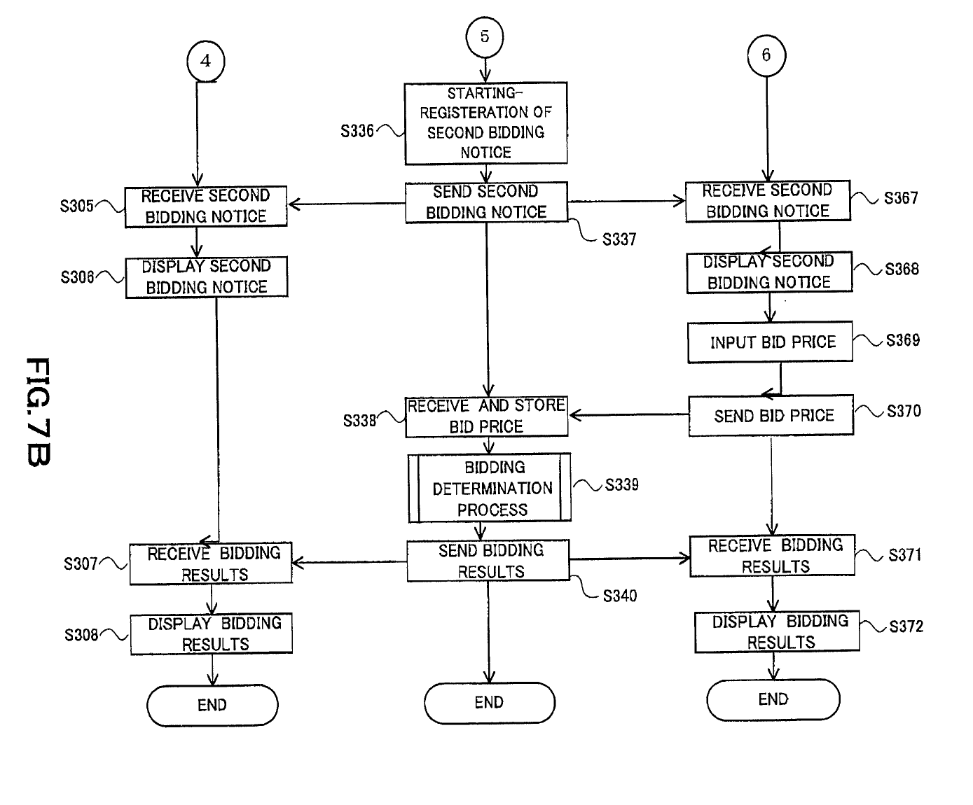

FIGS. 7A and 7B are flow charts to show the twice bidding process. If the way of transaction selected by the seller is twice bidding, the server 1 carries out the starting-registration of the first bidding. In the starting-registration, the point 10 after a certain period from the current time is fixed as the deadline of the first bidding, and the information about the start of the first bidding is stored in the transaction information database 16 along with the deadline information (step S331). Then, the CPU 11 makes e-mails to inform the start of the first bidding, and sends them with the communication device 13 through the Internet 4 to the e-mail addresses of the seller of the business object and the buyers who reserved the transaction (that is, the buyers registered in the transaction information database 16) (step S332).

In the seller terminal 2, when the communication device 25 receives the e-mail informing the seller about the start of the first bidding (step S301), the terminal shows the e-mail on the display device 24 (step S302). By this procedure, the seller can notice when the first bidding ends and when the highest price of the first bidding is opened as described later.

The buyer terminal 3 also receives the e-mail about the start of the first bidding from the server 1 with the communication device 35 (step S361), and then the terminal shows it on the display device 34 (step S362). By this procedure, the buyers who reserved the transaction of the business object can notice that the first bidding is started and then decide if they bid before the deadline. The buyers who decided to bid before the deadline of the first bidding also decide the bid price for the business object and input it from the input device 33 (step S363). In addition, by inputting a certain command, the buyers send the information about the first bid price to the server 1 with the communication device 35 (step S364).

Until the deadline of the first bidding registered in the step S331, the server 1 receives the information about the first bid price from the buyer terminals 3 via the communication device 13, and stores the information in the transaction information database 16 (step S333). After the deadline of the first bidding, the server 1 checks the information about the first bidding prices stored in the transaction information database 16, and it selects the highest bid price with a limit value from the stored information (step S334). The server 1 writes e-mails of the highest price information, and sends them via the Internet 4 to the addresses of the seller terminal 2 and the buyer terminals 3 of the buyers who reserved the transaction (step S335).

When the communication device 25 of the seller terminal 2 receives the e-mail informing the highest bid price from the server 1 (step S303), the terminal shows it on the display device 24 (step S304). By this procedure, the seller can notice the highest bid price for the first bidding.

The buyer terminal 3 also receives the e-mail of the highest bid price from the server 1 with the communication device 35 (step S365), and then shows it on the display device 34 (step S366). By this procedure, buyers can use the information as a reference when determining the bid price for the second bidding that is described later.

After a certain period since the sending of the e-mails about the highest bid price, the server 1 carries out the starting-registration for the second bidding. In the starting-registration, the point after a certain period from the current time is fixed as the deadline of the second bidding, and the information about the start of the second bidding is stored in the transaction information database 16 with the deadline information (step S336). Then, the CPU 11 makes e-mails to inform the start of the second bidding, and sends them with the communication device 13 through the Internet 4 to the e-mail addresses of the seller of the business object and the buyers who reserved the transaction (step S337).

In the seller terminal 2, when the communication device 25 receives the e-mail informing the seller about the start of the second bidding (step S305), the terminal shows the e-mail on the display device 24 (step S306). By this procedure, the seller can notice when the second bidding ends, and results of the second bidding will be opened up.

The communication device 35 of the buyer terminal 3 also receives the email from the server 1 about the start of the second bidding (step S367), and then the terminal shows it on the display device 34 (step S368). By this procedure, the buyers who reserved the transaction of the business object can notice that the second bidding is started and decide if they bid before the deadline. The buyers who decided to bid before the deadline of the second bidding decides the bid price for the business object by referring the highest price of the first bidding shown in the step S366, and input it from the input device 33 (step S369). In addition, by inputting a certain command, the buyers send the information of the second bid price to the server 1 with the communication device 35 (step S370).

Until the deadline of the second bidding registered in the step S336, the server 1 receives the information about the second bid price from the buyer terminals 3 with the communication device 13, and stores it in the transaction information database 16 (step S338). After the deadline of the second bidding, the server 1 carries out the bidding determination process described below, and determines a successful bidder and a contract price (step S339).

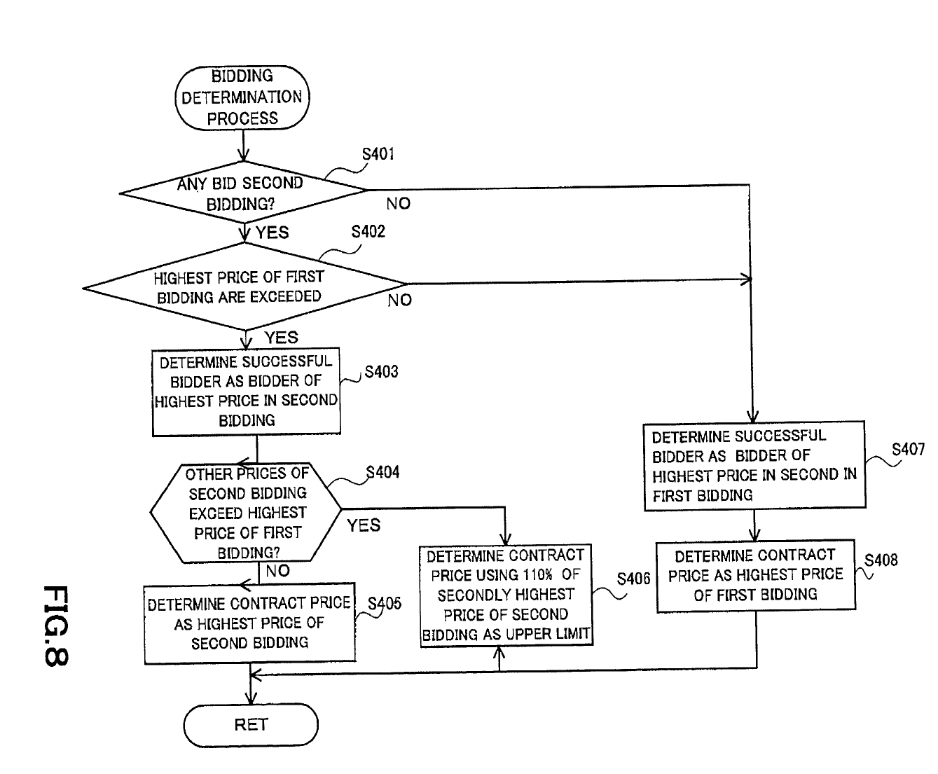

FIG. 8 is a flow chart showing details of the bidding determination process in step S339. In this process, the CPU 11 judges if information about the second bid price is sent from any one of the buyer terminals 3, by checking the transaction information database 16 (step S401). If no information was sent from buyer terminal 3, the process proceeds to the step S407 described later.

If second price information has been sent from any one of the buyer terminals 3, the CPU 11 further check the transaction information database 16, and decides if there are any bid prices of the second bidding that are higher than the highest bid price of the first bidding (step S402). If there is no second bidding price higher than the highest bid price of the first bidding, the process proceeds to the step S407 described later.

If there is any bid price of the second bidding higher than the highest bid prince of the first bidding, the CPU 11 determines the buyer who offered the highest bid price in the second bidding as the successful bidder of the business object (step S403). Furthermore, it checks the transaction database 16 to decide if there are bid prices of the second bidding, except that of the successful bidder, that are higher than the highest bid price of the first bidding (step S404).

If there is no other bidding of the second bidding that is higher than the highest bid price of the first bidding, the contract price is determined as the highest bid price of the second bidding (step S405). Then the bidding determination process is ended, and returns to the process of the FIG. 7B. On the other hand, if there are bid prices in the second bidding, except that of the successful bidder, that are higher than the highest bid price of the first bidding, the contract price is determined as the lower price between the successful bidder's price and the 110% of the secondly highest bid price (step S406). Then the bidding determination process is ended, and returns to the process of the FIG. 7B.

If there was no second bidding or no bidding higher than the highest bid price of the first bidding, the bidder who offered the highest bid price in the first bidding is determined as the successful bidder, in the step S407. Then the highest bid price of the first bidding is determined as the contract price (step S408). Then the bidding determination process is ended, and returns to the process of the FIG. 7B.

Now returning to the process shown in FIG. 7B, the CPU 11 of the server 1 makes e-mails about the information of the successful bidder and the contract price determined in the bidding determination process, and then send it to the email addresses of the sender and the buyers, who participated in the first or second bidding, via the Internet 4 (step S340).

When the communication device 25 of the seller terminal 2 receives the e-mail about the results of the bidding (step $307), the server shows it on the display device 24 (step S308). By this information, the sellers can notice who the successful bidder of the business object is, and what the contract price is.

The buyer terminal 3 also receives the e-mail about the result of the bidding from the server 1 with the communication device 35 (step S371), and then the terminal shows it on the display device 34 (step S372). By this information, the buyers who participated in the first and the second bidding can notice if they successfully bid the business object or not, and what the contract price is.

According to the e-mail about the bidding results, the buyer succeeded in bidding and the seller communicate with each other, and they carry out the transference of the business objects and the payment at the contract price.

Now, if no information was inputted from any buyer terminals 3 in the step S333 of the second bidding process, the server 1 sends a e-mail informing the result to the seller, and then terminates the process. Besides, the inputting/sending processes of the bid price of the first bidding in steps S363 and S364 do not have to be carried out. The inputting/sending processes of the bid price of the second bidding in steps S369 and S370 also do not have to be carried out.

As so far described, in this embodiment of the network transaction system sends business object information suggested by a seller to buyers, and gets the buyers to reserve the transaction. The seller then gets information about the state of the transaction reservation before actually conducting the transaction. The seller can predict the demand of the business object according to the reservation state, and then select the proper way of transaction. By this procedure, it is possible to make the transaction period and price proper.

In addition, the system registers buyers' conditions of the business object to the buyer information database in advance, and finds conditions that correspond to a business object proposed by a seller (matching process). The information about the business object is then sent to the buyers selected by the matching process. Therefore, the procedure makes it possible for buyers to avoid unwanted information, and to get necessary information about the business objects they wish without watching the transaction.

Furthermore, the sellers and buyers who are not registered as members in advance cannot use the system. Thus, troubles such as failure to transfer the business object or to settle the payment can be avoided as much as possible.

In addition, in this embodiment of the network transaction system, if a seller chose to carry out the transaction in twice bidding, buyers can determine final bid price by referring the result of the first bidding. Therefore, buyers can avoid bidding in extremely high prices, and it makes the contract price of the business object proper,

The final contract price after the second bidding can be determined based on the secondly highest price in the second bidding. Thus, even if one of the buyers bid fairly high price, the contract price can be proper On the other hand, sellers can expect buyers to propose higher prices, considering the mechanism for contract price determination.

Furthermore, the sellers and buyers who are not registered as members in advance cannot use the system. Thus, troubles such as failure to transfer the business object or to settle the payment can be avoided as much as possible.

The present invention is not limited to the above embodiment of it, and it can be applied various changes. Practical variations of the above embodiment of the present invention are described below.

In the above embodiment of the present invention, ID and PW are sent to the registered sellers or buyers via the Internet 4. However, ID and PW can be sent to them by facsimiles or mails. Also, it can be used other measures of identification than ID and PW for identifying the registered sellers or buyers.

In the above embodiment of the present invention, business object information is sent via e-mail to the buyers who are chosen by the matching 16 process. On the contrary, it is possible to send e-mails that only inform the buyers they were selected as a result of the matching process, and then get the buyer to access the certain homepage provided by the server 1 to obtain detail information about the business object.

In the above embodiment of the present invention, the buyers' conditions of the business objects are registered in the buyer information database 15. Then the system informed the buyer when their condition matched the business object proposed by sellers. On the contrary, it is possible to deliver business object information to all the buyers registered in the buyer information database 15. In this case, buyers can judge if each business object corresponds to their demand, and make reservation of the transaction.

In the above embodiment of the present invention, the system receives reservations for transactions from buyers for a certain period, and after the end of the period it sends e-mail of the state of reservation to the seller. On the contrary, from the seller terminal 2, the seller can access certain homepages provided by the server 1, and can immediately check the state of reservation.

In the above embodiment of the present invention, the system sends the reservation state of the business objects to the sellers, and makes them possible to predict demand of the business object. On the contrary, the system can send the results of the matching process in step S233 to the sellers. The sellers can also predict the demand using the results of the matching. In this case, a transaction of business object can be started even if the seller cannot get the information about reservation state, and the time between the registration of the business object and the end of the transaction can be shorter. Also the result of the matching in step S233 can be sent to buyers. In this case, the buyers also can predict the demand of the business object, and they can use the information to decide if they reserve the transaction or not and what price they should propose in the first bidding.

In the above embodiment of the present invention, the buyers' conditions are registered in advance, and the matching process is carried out each time business objects are proposed by sellers. On the contrary, it is possible to register the business objects that are proposed by sellers to the seller information database 14, and then carry out the matching process with the buyer information database 15 in every certain period of time. Besides, buyers may suggest their condition of business objects each time, and then carry out matching process with the business objects registered in the seller information database 14. In these cases, the system can also inform the sellers about the result of the matching process, offering a measure to predict the demand for the business objects.

In the above embodiment of the present invention, the sellers and buyers who can transact the business objects are limited to those who are registered as members in advance. However, it is possible to make the system available without requiring such member registration processes. In this case the sellers can freely register business objects they wish to sell, and the registered business object information are open for everyone. If buyers who accessed the information wish to buy the business objects, they can reserve transaction.

In the above embodiment of the present invention, the ways of transaction that sellers can choose from include: the way in which sellers set the price and calls for buyers on first-in-first-served basis, auction, and bidding (once or twice bidding). However, the methods are not limited to the above example. For example, bidding can be done more than three times.

In the above embodiment of the present invention, sellers can select the way of transaction optionally regardless how many transaction reservations are made for the business objects. On the contrary, it is possible to limit the choice of the way of transaction according to the reservation state. For example, the twice bidding described above may be limited to the situation when there are more than a certain number of reservations or a certain number of buyers who are selected by the matching process.

In the above embodiment of the present invention, the transference and the settlement of business objects are carried out between the seller and the buyer, and the system is not related to this process. On the contrary, the system may collect deposits at some points of transaction, for example transaction reservation or any stage of the way of transaction the seller selected. The deposit collection may be conducted according to the information about the way of settlement registered in the buyer information database 15. When the buyer is determined, the system can appropriate the buyer's deposit for a part of the settlement of the business object. In this way, failure of settlement can be avoided to a certain extent, and the safety of the transaction can be acquired.

In the above embodiment of the present invention, the system sends emails that inform all of the buyers who reserved the transaction about the results of the first and the second bidding. However, the e-mail about the result of the second bidding may be sent to only the buyers who participated in the first bidding. In this case, the period for the second biding can be set shorter, and the time required to decide the successful bidder can be shortened. In addition, e-mails, especially those for the first bidding, may be sent to all the buyers who are registered in the buyer information database 15, regardless whether the buyer reserved for the business object or not.

In the above embodiment of the present invention, the system sends emails to the seller terminal 2 and the buyer terminal 3, to inform the seller and the buyers about the highest bid price of the first bidding, and the final result of the bidding. However, the seller or the buyers can check the information by accessing certain homepages that are provided by the server 1, using their terminals. In this case, they can notice that the highest bid price of the first bidding is determined, by the notice of the second bidding. It is also possible to inform them that the result of the bidding is determined, without informing them about the details of the result.

In the above embodiment of the present invention, the contract price determined after the second bidding is limited to 110% of the secondly higher bid price (in this case the price must be higher than that of the first bidding). However, the rate is arbitrary, and it may be 120%. In addition, the limit price may be the secondly highest price added with a certain value. For example, if the rule is adding 10,000 yen to the secondly highest price, the contract price is determined as 170,000 yen for the prices of 200,000 yen and 160,000 yen for the firstly and the secondly highest prices, respectively. In the same way, the contract price is 100,000 yen for the prices of 100,000 yen and 95,000 yen for the firstly and the secondly highest prices, respectively.

In the above embodiment of the present invention, if sellers select twice bidding as the way of transaction, the second bidding is carried out as long as there is bidding from the buyer terminal 3, regardless the highest bid price informed after the deadline of the first bidding. On the contrary, it is possible to set rules such that the sellers can decide if they carry out the second bidding, according to the highest bid price of the first bidding shown in the step S304. If the sellers decided not to carry out the second bidding, they may determine the contract price according to the result of the first bidding, or they may decide not to sell the business objects to any buyers, without doing further procedures. In this way, the sellers can avoid to sell the business objects at a price they think improper.

In the above embodiment of the present invention, we described the twice bidding such that one more bidding is done after announcing the highest bid price of the first bidding. However, transactions with bidding more than three times may be possible. In this case, by comparing the highest bid prices for the first and the second biddings, it can be decided whether to carry out the third bidding or not. For example, the third bidding may be carried out if the highest bid price for the second bidding is more than 120% of that for the first bidding. Similarly, it may be decided that the contract price is determined by the second bidding if the highest bid price for the second bidding is less than 120% of the first bidding. Besides, when the third bidding is carried out, the buyers may bid the price less than that of the second bidding, without restricted to the result of the second bidding. In this case, if the highest bid price of the third bidding is higher than that of the first bidding, the former price can be the contract price.

In the above embodiment of the present invention, the seller terminal 2 and the buyer terminal 3 are connected to the server 1 via the Internet 4, which is open network. On the contrary, these terminals can be connected to the server 1 via closed network.

In the above embodiment of the present invention, the programs shown in the flow charts of FIG. 5-FIG. 8 are described as those stored in storage 12, 22, and 32 in advance. However, at least a part of these programs may be stored in media readable with computers such as CD-ROMs and DVD-ROMs, and may be distributed and installed in personal computers. Also, the programs may be stored in the hard disks of servers on the Internet 4, and it may be installed in personal computers after downloading via the Internet 4.

This application is based on Japanese Patent Applications Nos. 2001-231396 and 2001-231397, both of which were filed on Jul. 31, 2001, and we claim the priority of the invention. The disclosures of these applications are incorporated herein by reference in its entirely.

What is claimed is:

1. A system for transaction mediation connected to seller's and buyer's computers comprising:
means for receiving business object information received business object information proposed by a seller;
means for releasing said business object information to multiple buyers;
means for receiving reservation for transactions received reservation made by said buyers for said business object information;
means for providing reservation providing a state of said reservation for said seller;
means for receiving transaction way receiving a transaction way selected by said seller from multiple transaction ways prepared in advance; and
means for processing transaction executing a process for accomplishing a transaction of said business object between said seller and said buyer.

2. The system according to claim 1, further including:
means for registering buyer's information about said multiple buyers who transact said business object; and
said means for releasing said business object information to said multiple buyers, sending said business object information to buyers registered in said ways for said registering buyer's information.

3. The system according to claim 1, wherein:
said means for registering buyers' information stored buyers' conditions of said business object;
means for selecting buyers extracting buyers fulfilled with conditions of said business object, by comparing said business object with said conditions; and
said means for releasing said business object information to said selected buyers.

4. The system according to claim 1, wherein: said transaction mediation system connected to multiple buyer terminals via network, said means for releasing carrying out transference of said business object information to buyers' terminals via said network.

5. A system for transaction mediation, comprising:
a communication device;
a control unit; and
a storage;
wherein said system connected via network to computers operated by sellers and buyers; said storage stored information about buyers' conditions of business object; said control unit carrying out the following processes; 1) receiving information about a business object proposed by a seller with said communication device; 2) releasing received business object information with said communication device; 3) receiving reservations made by buyers for transaction of released business object with said communication device; 4) providing information about a state of reservation to said seller with said communication device; 5) receiving information about a way of transaction specified by said seller, with said communication device; and 6) carrying out processes necessary for accomplishing a transaction between said seller and said buyer.

6. A system for transaction mediation, comprising:
means for receiving business object information proposed by a seller;
means for registering conditions of business objects for said buyers;
means for comparing for comparisons between information received by said means for receiving business object and that registered in said means for registering conditions;
means for receiving a way of transaction chosen by said seller from selections of ways of transaction prepared in advance, according to results of said comparison;
and means for processing transaction carrying out necessary processes or accomplishing a transaction between said seller and said buyer in said way of transaction.

7. A system for transaction mediation, comprising:
a communication device;
a control unit;
a storage; and
wherein said system connected via network to computers operated by sellers and buyers; said storage storing information about buyers condition of business object proposed by a seller; and said control unit carrying out the following processes; receiving information about a business object proposed by a seller with said communication device; comparing received business object information with condition information registered in said means for registering conditions; selecting a seller according to results of comparison; informing selected seller via said communication device; receiving a way of transaction chosen by said seller according to results of said comparison, and chosen from selections of ways of transactions prepared in advance; and conducting processes necessary for accomplishing a transaction between said seller and said buyer in received way of transaction.

8. A system for transaction mediation, comprising:
a step of receiving business object information proposed by a seller;
a step of releasing said received business object information for multiple buyers;
a step of receiving reservations made by said buyers for a transaction of said released business objects;
a step of providing a state of said reservation for said seller;
a step of receiving a way of transaction chosen by said seller according to a state of reservation, from selections of ways of transactions prepared in advance; and
a step of conducting processes necessary for accomplishing a transaction between said seller and said buyer in said way of transaction received.

9. A system for transaction mediation, comprising:
a step of receiving business object information proposed by a seller;
a step of comparing received business object information with condition information registered in advance;
a step of receiving a way of transaction chosen by said seller according to results of said comparison, from selections of ways of transactions prepared in advance; and
a step of conducting processes necessary for accomplishing a transaction between said seller and said buyer in said received way of transaction.

10. Programs for operating computers, comprising:
a step of receiving business object information proposed by a seller;
a step of releasing received business object information for multiple buyers;
a step of receiving reservations made by buyers for a transaction of said released business objects;
a step of providing reservations for said seller a state of said reservation;
a step of receiving a way of transaction chosen by said seller from selections of ways of transactions prepared in advance, according to said state of reservation; and
a step of conducting processes necessary for accomplishing a transaction between said seller and said buyer in said received way of transaction.

11. Programs for operating computers, comprising:
a step of receiving business object information proposed by a seller;
a step of comparing received business object information with registered condition information;
a step of receiving a way of transaction chosen by said seller according to results of said comparison, from selections of ways of transactions prepared in advance; and
a step of conducting processes necessary for accomplishing a transaction between said seller and said buyer in said received way of transaction.

12. A bidding system connected via network to computers operated by sellers and buyers, comprising:
means for receiving business object information proposed by a seller;
first means for releasing to send received business object information, in order to get first participant of transaction to bid for said business object;
first means for receiving bid price for a certain period receiving bid prices bid by second participant of transaction according to said released information;
means for selecting bid price choosing a bid price with limit value received in said first means for receiving bid price;
second means for releasing to send said selected bid price with limit value, in order to get second participant of transaction to further bid for said business object;
second means for receiving bid price for a certain period receiving bid prices bid by one or more buyers for said business object according to said released bid price with limit value; and
means for determining bidding of said business object, according to said bid prices received by said first and second means for receiving bid price.

13. The bidding system according to claim 12, wherein:
said means for determining bidding determines a successful bidder as a second participant of transaction who bid a price with limit value in said second bidding,
when one of prices received by said second means for receiving bid price is higher than said bid price with limit value selected by said means for selecting bid price.

14. The bidding system according to claim 12, wherein:
said means for determining bidding determines a contract price according to a price being next to a price with limit value received by said means for receiving bid price,
when a price received by said second means for receiving bid price, except that of said successful bidder, are more than a price with limit value selected by said means for selecting bid price.

15. The bidding system according to claim 12, wherein: said means for bidding determination releases said bid price with limit value received by said second means for receiving bid price, in order to get said second participant of transaction to further bid for said business object,
when said bid prices with limit values, received by said first and second means for receiving bid price, differ to more than a certain extent,

16. The bidding system according to claim 12, further including: means for transaction participants registration registering in advance multiple second participants of transaction who bid for said business object; said first means for releasing sending said business object information for second participants of transaction registered in said means for transaction participants registration.

17. The bidding system according to claim 12, wherein: said second means for releasing sending a bid price with limit value, selected by said means for selecting bid price, to second participants of transaction, from whom said first means for receiving bid price received a bid price.

18. The bidding system according to claim 12, further including: means for receiving stoppage information about transaction sent from said first participants of transaction according to said released bid price of first bidding; and means for stopping processes of said second means for receiving bid price and said means for bidding determination, by receiving transaction stoppage information from said means for receiving stoppage information.

19. The bidding system according to claim 12, wherein: said first participant of transaction corresponds to a seller of said business objects, and said second participant of transaction corresponds to buyer of said business object; and said bid price with limit value corresponds to a highest bid price.

20. The bidding system according to claim 12, wherein: said first participant of transaction corresponds to a buyer of said business object, and said second participant of transaction corresponds to seller of said business object; and said bid price with limit value corresponds to a lowest bid price.

21. A method of bidding, comprising:
a step of receiving business object information proposed by a seller;
a step of releasing said received business object information to said second participant of transaction in order to get them to bid for said business object;
a step of receiving prices bid within first period from said second participant of transaction according to said released business object information;
a step of selecting a bid price with limit value from said received bid prices;
a step of releasing said selected bid price with limit value to said second participant of transaction, in order to get them to bid furthermore for said business object;
a step of receiving, within second period, prices bid from multiple buyers for said business object according to said released bid price with limit value; and
a step of determining a bidding of said business object according to prices bid within said first and second periods.

22. Programs for operating computers, comprising:
a step of receiving business object information proposed by a seller;
a step of releasing to send received business object information, in order to get second participant of transaction to bid for said business object;
a step of receiving bid price receiving for a certain period a bid price, bid by second participant of transaction according to said released information;
a step of selecting bid price choosing a bid price with limit value from received prices in said first mean for receiving bid price;
a step of releasing to send said bid price with limit value, in order to get second participant of transaction to further bid for said business object;
a step of receiving bid price for a certain period, bid by one or more buyers for said business object according to said released bid price with limit value; and
a step of determining bidding of said business object, according to said bid prices received by said means for receiving bid price.
